(19) United States
(12) Patent Application Publication
(10) Pub. No.: US 2010/0002319 A1
(43) Pub. Date: Jan. 7, 2010

(54) TWO-POINT IMAGE FORMATION OPTICAL DEVICE

(75) Inventor: Satoshi Maekawa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: National Institute of Information and Communications Technology, Koganei-shi, Tokyo (JP)

(21) Appl. No.: 12/443,846

(22) PCT Filed: Sep. 27, 2007
(86) PCT No.: PCT/JP2007/068869

§ 371 Date: Apr. 1, 2009

(30) Foreign Application Priority Data
Oct. 2, 2006 (JP) 2006-271191

(51) Int. Cl. G02B 7/182

(52) U.S. Cl. 359/850

(57) ABSTRACT

A two-point imaging optical device utilizing an optical element that achieves a new type of imaging system, in which a two-point imaging optical element is provided with a plurality of mirrored surface portions arranged perpendicularly or at an angle close to perpendicular in a narrow interval between two parallel planes, which form an element plane, so as to be sandwiched between the two planes to form a flat panel shape, with the plurality of mirrored surface portions placed so as to be mutually isolated and parallel, or having an angle close to parallel between each mirrored surface portion, and an image of the subject of projection is formed in a space on the side of the element plane on which it has been placed, and another image of the subject of projection is formed in a space on the other side of the element plane.

### FIELD OF THE INVENTION

The present invention relates to a two-point imaging optical device that utilizes an optical element provided with two imaging points.

### BACKGROUND OF THE INVENTION

With respect to prior art technology that can serve for the purpose of comparison, there is known an optical system called an “anamorphic optical system” (see Non-patent Reference No. 1) in which the magnification rate in a lateral direction and a vertical direction are different. In order to realize the anamorphic optical system, a cylindrical lens or a toric lens (see Non-patent Reference No. 2) or the like is utilized. A cylindrical (cylindrical surface) lens have at least one surface that is formed like a portion of a cylinder, and is a lens widely used for correcting astigmatism occurring in the human eye, distance measuring devices, semiconductor lasers and the like; if subjected to a process for providing a surface of the lens with a mirror coating, the cylindrical lens can be used as a cylindrical mirror in scanners, facsimile machines and the like. A toric lens is a lens that has one or two toric surfaces, which are surfaces that have a maximum refractive power within a given meridian plane and a minimum refractive power in a meridian plane perpendicular to the aforementioned meridian plane; toric lenses are used as eyeglass lenses for correcting astigmatism, and the like.

Non-patent Reference No. 1: Dictionary of Rapid Solution Optical Science, p. 4, Optronics Co., 1998, ISBN:4-900474-72-X.

Non-patent Reference No. 2: Mr. Junpei Tsujiuchi, “Handbook of State-of-the-Art Optics Technology”, p. 22, Asakura Books, ISBN:10-4254210329.

### SUMMARY OF THE INVENTION

### Problems to be Solved by the Invention

In the case of conventional optical elements that have been provided with two imaging points, given a distance Z between a subject of which an image is to be projected (hereinafter, a “subject of projection”) and a front focus, a distance Z′ between an image of the subject of projection and a back focus, and a focal length f, the relationship expressed by the formula {ZZ′=f²} is formed, in which there is an inverse relationship between the distance Z and the focal length. Further, given a rate of magnetization M, the relationship expressed by the formula {Z=f/M} is formed, in which there is an inverse relationship between the distance Z and the rate of magnification. Accordingly, in imaging a three-dimensional (hereinafter, “3D”) body, a non-linear aberration is produced according to the depth.

The present invention relates to an optical element having imaging points that differ in respect of vertical and horizontal spread of lights, and by using a plurality of mirrored surfaces and not using a lens such as a conventional lens, an imaging system is obtained that has not existed until now, and a new type optical device utilizing a new type of two-point imaging optical element is provided.

### Means for Solving the Problems

That is to say, the two-point imaging optical device according to the present invention is provided with a two-point imaging optical element having plurality of mirrored surface portions placed at a perpendicular angle or at an angle close to perpendicular with respect to two parallel planes in a narrow interval between the two planes, which form an element plane, so as to be sandwiched vertically between the two planes to form a flat panel shape, in which the plurality of mirrored surface portions are arranged so as to be mutually isolated and parallel or having an angle close to parallel between each other, and an image of a subject of projection that has been disposed on one side of the element plane is formed in a space on the aforementioned one side of the element plane and another image of the aforementioned subject of projection is formed in a space on the other side of the element plane, respectively.

According to the two-point imaging optical element of the two-point imaging optical device according to the present invention having the above-described configuration, light emanating from a subject of projection (there are also cases in which the light is reflected light) is once reflected at a mirrored surface portion when the light passes through an interval between mirrored surface portions, and by passing through the optical element is imaged on both sides Es₁ and Es₂ of the element plane, respectively. Here, the imaging principle of the two-point imaging optical element will be explained with reference to FIG. 1. In FIG. 1, an illustrative example of two images created from a point light source S as viewed along the line of sight from a vantage point V is shown. In FIG. 1a, the light reflected from a single mirrored surface portion 2 is imaged at a position A, which is a position that is plane-symmetrical to the point light source S with respect to the aforementioned mirrored surface portion 2, and the manner in which an image appears in a space to one side Es₂ of the element plane of the optical element 1 (in the example shown in the drawing, the lower side) seen from the vantage point V of an observer, is shown. Note that the image point A is a virtual image that is equivalent to an image in a single mirror, and in actuality light rays are not gathered at the point A. Next, in FIG. 1b, the manner of the reflection occurring at the position of a perpendicular line common to each of the mirrored surface portions 2 is shown. Because the reflection of the light rays at the mirrored surfaces passes though a path that has line symmetry with respect to a perpendicular line passing through the reflection position, ultimately, the light reflected from each of the mirrored surfaces 2 comes to pass through a point B, which is a position that is line-symmetrical to the point light source S with respect to a common perpendicular line 1. In this manner, the real image of the point light source S is formed at a point B occurring in a space to the other side Es₁ of the element plane (in the example shown in the drawing, the upper side). However, in the case that the subject of projection as a convergence of the point light source S is three-dimensional, the real image, which is the convergence on the point B, is observed with the ordering of the depth characteristics appearing in an inverted state. Because the above-described imaging occurs simultaneously, as shown in FIG. 1c, images appear at both of the two imaging points of point A and point B. Note that, when viewed from the vantage point V, because both the imaging points can be seen along the same line of sight, the two imaging points are observed as a single imaging point.

Because the two-point imaging optical device of the present invention is provided with a two-point imaging optical element having a simple configuration in which a plurality of mirrored surface portions arranged in a predetermined manner, which is capable of providing two element plane sides each of which forms a respective imaging point, an imaging device that makes it possible to view an image the type of which has not existed until now can be obtained. Note that the two-point imaging optical device according to the present invention can be a device that is provided with the a two-point imaging optical element such as that described above, or can be formed solely from a two-point imaging optical element.

Next, a detailed explanation of the positional relationship of the imaging performed by the two-point imaging optical element applied in the present invention will be provided. In FIG. 2, a subject of projection (a point light source) is designated as S, a vantage point of an observer as V, a straight line passing through S and V as m, a point of intersection between m and the element as C, and a line perpendicular to the mirrored surface portions and passing through C as 1. The perpendicular line 1 is a perpendicular line common to each mirrored surface portion. As shown above, the position that is line-symmetrical to S with respect to the common perpendicular line 1 is B. Further, if a straight line passing through V and B is designated as n, and a point of intersection between the straight line n and the common perpendicular line 1 as D, then A becomes a point on the straight line n that satisfies the condition line segment SD=line segment DA. Note that, the element plane includes the straight line 1; however, the plane including V, S, and A is not required to be perpendicular to the element planes Es₁ and Es₂. In addition, if a virtual plane P including the point light source S and which is parallel to the element planes Es₁ and Es₂ is considered, the point A resides on the plane P, and if a virtual plane Q located at a position which is plane-symmetrical to the plane P with respect to the element planes is considered, the point B resides on the plane Q.

Next, aberration occurring with the two-point optical element will be explained, first with reference to FIG. 3 for aberration in the vertical and depth-wise directions from the vantage point V. In FIG. 3, if the point light source S is moved to a position S′ in parallel with the element planes Es₁ and Es₂, the points A and B are moved in parallel with the element planes Es₁ and Es₂ to points A′ and B′, respectively. In other words, BB′ is equivalent to SS′; however, AA′ is expanded more than SS′. Further, if the point light source S is moved to a position S″ located in a direction that is close to being perpendicular to the element planes Es₁ and Es₂, the points A and B are moved in to points A″ and B″, respectively. That is to say, AA″ is expanded more than SS″, which becomes diagonal with respect to the element planes Es₁ and Es₂, SS′; however, BB″ maintains a value equivalent to SS″, and a direction of BB″ becomes the inverse of the direction of SS″. On the other hand, aberration in the lateral direction from the vantage point V will be explained with reference to FIG. 4. In FIG. 4, if the point light source S is moved to a position S′″ in parallel with the element planes Es₁ and Es₂, the points A and B are moved in parallel with the element planes Es₁ and Es₂ and also in parallel with the common perpendicular line 1 to points A′″ and B′″, respectively. In other words, AA′″ maintains a value equivalent to SS′−; however, BB′″ is contracted more than SS′″. Here, if a distance from the element planes Es1 and Es2 to the vantage point V is designated as R, and a distance from the element planes Es1 and Es2 to the point light source S as r, the relationship of the distances R and r and to size of the subject of projection is expressed by the following formula.

BB′″={(R−r)/(R+r)}SS′″ Formula 1

That is to say, if the relations described above are summed up, the image formed above the upper side element plane Es₁ shown in FIG. 4 is of a dimension that has been contracted in the lateral direction, and of an equivalent dimension in the other two axial directions. On the other hand, the image formed beneath the lower side element plane Es₂ shown in FIG. 4 is of an equivalent dimension in the lateral direction; however, the dimensions along the other two axial directions the aforementioned image have been expanded.

Note that, according to the present invention, the ‘planes’ described in the phrase “a narrow interval between two parallel planes, which form an element plane” are subject to change depending on the application of the present invention or the size of the object that is to be projected; however, the planes are placed close together mutually separated by an interval of from several microns to several centimeters, and it is not necessary that the planes are physically existing planes, as virtual planes will suffice. For example, when the image of the subject of projection is to be observed from the element at a short distance of from several microns to several centimeters, it is preferable that the interval between the above described two planes is several microns to several tens of microns; in the case that the image of the subject of projection is to be observed from the element at a short distance of from several centimeters to several meters, it is preferable that the interval between the above described two planes is several tens of microns to several hundreds of microns, and in the case that the image of the subject of projection is to be observed from the element at a short distance of from several meters to several tens of meters, it is preferable that the interval between the above described two planes is several hundreds of microns to several millimeters.

Further, according to the present invention, the above-described “a perpendicular angle or at an angle close to perpendicular . . . between two parallel planes”, means “an angle that is in the range from an angle that is exactly perpendicular to the two planes to an angle within an error range of several minutes of a degree from perpendicular”. Still further, the above-described “plurality of mirrored surface portions are arranged so as to be mutually isolated and parallel or having an angle close to parallel between each other” means “all mirrored surface portions are completely parallel, or at an angle within an error range of several minutes of a degree from parallel”.

According to the two-point imaging optical device of the present invention such as that described above, to eliminate excess reflected light and increase the resolution of the image of the subject of projection, it is desirable that a rear surface of the mirrored surface portions of the two-point imaging optical element is a non-mirrored surface.

According to the two-point imaging optical element configuring the two-point imaging optical device according to the present invention such as that described above, each mirrored surface portion is also capable of being divided, and each mirrored surface portion may be formed from a plurality of mirrored surface elements each of which is arranged substantially within the same plane and mutually separated from each other. Each mirrored surface portion can be formed by a rectangular mirror; however, if a single mirrored surface portion is formed in the above-described manner from a plurality of mirrored surface elements residing substantially on the same plane oriented toward the subject of projection, in comparison to the case in which both ends of the rectangular mirror are supported, it becomes possible to easily support the degree of parallel of a plurality of mirrored surface portions or the degree of flatness of each of the mirrored surface portions. Note that, with respect to the meaning of “a plurality of mirrored surface elements arranged in substantially the same plane”, although the case in which the plurality of mirrored surface elements reside completely within the same plane is favorable, parallel displacement within the same plane, or an error range of several minutes of a degree is permissible.

A more specific basic configuration of the two-point imaging optical device according to the present invention can be described as one in which the mirrored surface portions are capable of being maintained in an appropriate posture by a supporting member, the configuration including: a plurality of mirrored surface portions arranged at a perpendicular angle or an angle close to perpendicular sandwiched between two planes, which form an element plane, so as to form a flat panel shape; and a supporting member for supporting the plurality of mirrored surface portions so that all of the plurality of mirrored surfaces are oriented in the same direction and disposed so as to be mutually isolated and parallel or separated by an angle close to parallel; in which, when the subject of projection is arranged in a space before the rear surface of the supporting member in contraposition to the mirrored portions, the image of the subject of projection is reflected from each of the mirrored surface portions through the interval between each mirrored surface portion, and a respective image of the subject of projection is formed in a space on each of a front surface side and a rear surface side of the supporting member.

Further, according to the two-point imaging optical device of the present invention, in order to maintain the plurality of mirrored surface portions in an appropriate posture and to protect the plurality of mirrored surface portions, the supporting member can be formed from hard transparent members disposed along the two element planes for sandwiching the plurality of mirrored surface portions and which are disposed so as to be mutually horizontal or have a bearing close to horizontal. In regard to appropriate materials for the hard transparent members, glass or acrylic, for example, are examples of materials that can be used.

Alternatively, the two-point imaging optical device according to the present invention can also be provided in an configuration in which the plurality of mirrored surface portions of the two-point imaging optical element are formed within a supporting member which is a supporting element for supporting the plurality of mirrored surface portions; in which, the supporting member can be formed from a thin panel shaped member configured from a transparent hard material such as glass, acrylic or the like on which are formed a plurality of any of streak shaped grooves, slits, or protrusions arranged at a mutually parallel or close to a parallel angle, and the surface of the side of each of the streak shaped grooves, slits, or protrusions facing the subject of projection is a mirrored surface portion. In this manner, fabrication of a two-point imaging optical element in which the disposition of the mirrored surface portions is regular and according to specification can be made simple and easy.

From a similar standpoint, an embodiment of the two-point imaging optical device according to the present invention in which the mirrored surface portions are formed within the supporting member itself is also possible; the supporting member can be formed from a thin panel shaped member on which are formed a plurality of hole portions passing through a direction of a thickness of a panel wall of the supporting member or a plurality of transparent tube shaped portions projecting in a direction of a thickness of a panel wall of the supporting member arranged in a planar lattice pattern, in which a mirror surface element for reflecting light is formed on a surface among surfaces of each of the hole portions or tube shaped portions that faces toward the same side, whereby the above-described single mirrored surface portion can be configured from a plurality of mirrored surface elements formed substantially within the same plane.

According to a configuration such as that described above, in the case that the refractive index of the interior of the hole portions or tube shaped portions exceeds 1, satisfying the conditions for a transparent liquid or solid, it becomes possible to conveniently adjust the angle from which the image of the subject of projection is observed.

Further, in the case that the subject of projection is an object with movement or an image with movement, it is also possible to obtain an embodiment of the two-point imaging optical device according to the present invention that enables the observation of an real image and a virtual image that move in correspondence with the action of the subject of projection by imaging the real image and the virtual image at two respective imaging points.

Still further, in the case that a distance of each part of the subject of projection is not uniform from the element plane or fluctuates, it becomes possible to reproduce an real image of the correct size of the subject of projection by adjusting the width of the subject of projection in accordance with the distance thereof from the element planes, that is to say, making the width dimension of the subject of projection in a direction parallel to the element plane and mirrored surface portion capable of being expanded and contracted.

### Effects Achieved by the Invention

According to the two-point imaging optical device of the present invention, by providing a two-point imaging optical element of a simple configuration in which a plurality of mirrored surface portions are lined up substantially parallel in a row and provided in a substantially perpendicular posture between two element planes that are separated by a small interval, light emanating from a subject of projection is reflected from each mirrored surface portion to form an image in a space on each of side of the element plane, whereby an imaging apparatus that has an imaging system which is capable of obtaining a total of two images and has not existed heretofore is created. Because the two-point imaging element applied according to the present invention provides a completely different aberration in the imaging of an object compared to a conventional anamorphic optical system, and particularly in the case of imaging a 3D body, it can be said that the two-point imaging element according to the present invention confers a new degree of freedom to the field of optical systems design.

Further, according to a two-point imaging optical device such as that of the present invention, because the aforementioned device of the above-described configuration is characterized in that it projects an image of a subject of projection onto respective spaces on the sides of both the front and rear element planes of the two-point imaging optical element according to the present invention, it can be used in a display apparatus or exhibition apparatus having a new type of imaging system that has not existed before.

In particular, if the optical device is of a configuration in which the two-point imaging optical element is an element in which the element planes and the mirrored surface portions have been arranged so as to be disposed perpendicularly with respect to the perspective of an observer viewing in a natural posture from the vantage point V, explained with reference to FIGS. 1b and 16, because the binocular disparity direction has a vertical component with respect to the element planes Es₁ and Es₂, an image formed at the point B, which is a position that is line-symmetrical to the point light source S with respect to the common perpendicular line 1, by light emitted from the point light source S and reflected from each mirrored surface portion 2, that is to say, the real image that appears floating on the side even closer to the observer than the two-point imaging optical element (i.e., on the vantage point side) becomes easier to observe by priority. However, in the case that the subject of projection is a 3D body, the ordering of the depth characteristics occurring in the real image observed appearing in the inverse state.

On the other hand, in the case that the optical device is of a configuration in which the two-point imaging optical element is an element in which the element planes have been arranged at a horizontal bearing and the mirrored surface portions at a vertical bearing, explained with reference to FIG. 1a, according to the perspective of an observer viewing in a natural posture from the vantage point V, because the binocular disparity direction becomes parallel to the element planes, an image formed at the point A, which is a position having plane-symmetry to the point light sources S with respect to a single mirrored surface portion 2 from which a beam of light emitted from the point light source S has been reflected, that is to say, the virtual image that can be seen in the background area of the two-point imaging optical element becomes easier to observe by priority.

Further, according to the optical device of the present invention, a subject of projection is placed in a space that is to the rear surface side of a supporting member and counterposed to a mirrored surface portion when viewed from the vantage point of an observer, and by making the subject of projection an inverse 3D object or an inverse 3D moving image of which the ordering of the depth characteristics has been inverted, in particular, the depth of an real image of a subject of projection that is observed appearing in front of the two-point imaging optical device can be viewed as a 3D image or 3D moving image having the correct original depth ordering.

### BRIEF DESCRIPTION OF THE DRAWINGS

FIG. 1 is a conceptual drawing of the imaging principle of the two-point imaging optical element applied in a two-point imaging optical device according to the present invention.

FIG. 2 is a conceptual drawing of the positional relationship of the imaging process occurring in the same imaging element of FIG. 1.

FIG. 3 is a conceptual drawing showing the aberration in the vertical and depth-wise directions from a vantage point occurring in the same optical element of FIG. 1.

FIG. 4 is a conceptual drawing showing the lateral aberration occurring in the same imaging element of FIG. 1.

FIG. 5 is a schematic drawing of the configuration of a two-point imaging optical element according to an embodiment of the present invention.

FIG. 6 is a schematic drawing of the basic configuration of a two-point imaging optical device according to an embodiment of the present invention.

FIG. 7 is a schematic drawing of the basic configuration of a two-point imaging optical device according to another embodiment of the present invention.

FIG. 8 is a schematic drawing of the basic configuration of a two-point imaging optical device according to yet another embodiment of the present invention.

FIG. 9 is a schematic drawing of the basic configuration of a two-point imaging optical device according to still yet another embodiment of the present invention.

FIG. 10 is a schematic drawing of the basic configuration of a two-point imaging optical device according to yet still another embodiment of the present invention.

FIG. 11 is a schematic drawing of the basic configuration of a two-point imaging optical device according to even yet still another embodiment of the present invention.

FIG. 12 is a schematic drawing of the basic configuration of a two-point imaging optical device according to still even yet another embodiment of the present invention.

FIG. 13 shows a display device which is an example of an apparatus in which the two-point imaging optical device shown in FIG. 11 has been applied.

FIG. 14 shows an overview of the imaging system occurring in the two-point imaging optical device of the same display device of FIG. 13.

FIG. 15 shows another example of a display device which the two-point imaging optical device shown in FIG. 11 has been applied.

FIG. 16 shows an overview of the imaging system occurring in the two-point imaging optical device of the same display device of FIG. 15.

FIG. 17 is a conceptual drawing showing the lateral aberration occurring from a vantage point of a two-point imaging optical element applied in an embodiment according to the present invention in the case that the subject of projection is an object with movement.

### DETAILED DESCRIPTION OF THE EMBODIMENTS

Hereinafter, preferred embodiments of the present invention will be described in detail with reference to the drawings.

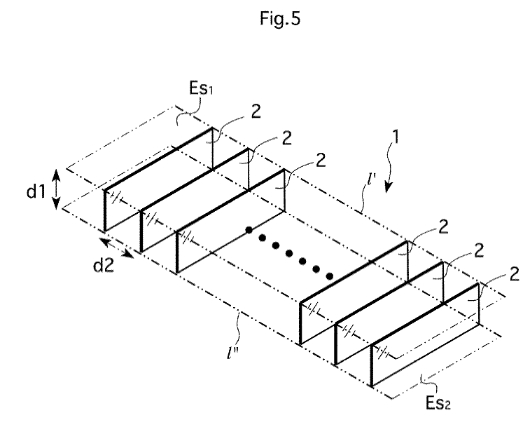

FIG. 5 shows a schematic drawing of the basic configuration of an embodiment of a two-point imaging optical element (hereinafter referred to simply as an “optical element”) applied according to the present invention. As shown in FIG. 5, the optical element 1 comprises a plurality of smooth and flat, long and narrow mirrored surface portions 2, in which each of the mirrored surface portions 2 is arranged lined up parallel so as to be oriented in the same direction separated by an equidistant interval between the mirrored surface portion positioned in both the forward and backward directions. Each mirrored surface portion 2 can be formed from, for example, a thin panel shaped mirror member of which the front surface is a mirror surface. Further, in order to prevent excess reflection from surfaces other than the mirror surfaced portions 2, it is desirable that the rear surface of the mirrored surface portions 2 of a mirrored member such as that described above is a non-mirrored surface. In the example shown in the drawing, each mirrored surface portion 2 is enclosed on the upper edge and the lower edge thereof within element planes Es1 and Es2, respectively, which configure a plane 1′ and plane 1″. Each mirrored surface portion 2 is in a perpendicular relationship with both of the planes 1′ and 1″.

The interval between the flat surfaces 1′ and 1″ (in other words, the dimension of the width of the mirrored surface portions 2 (in the example shown in the drawing, the height direction), or to put it even another way, the thickness of the element) d1 is determined based on a relationship with an interval d2 between adjacent mirrored surface portions 2, 2. The ratio d1/d2 is related to the optimal observation angle of the optical element 1. If the value of the aforementioned ratio is 1, that is to say, if d1=d2, it is best to view the element planes Es₁ and Es₂, which come to have a maximum transmission factor, from a direction of 45 degrees. If the value of the ratio is smaller than 1, that is to say, if the value of d1 is smaller than the value of d2, it is desirable that the element planes Es₁ and Es₂ are viewed from a shallow angle that is near parallel; furthermore, if the value of the ratio is larger than 1, that is to say, if the value of d1 is larger than the value of d2, it is optimal that the element planes Es₁ and Es₂ are viewed from a deep angle that is near perpendicular.

On the one hand, the interval d2 between two mirrored surface portions mirrored surface portion 2 and mirrored surface portion 2 determines the resolution of the said optical element 1. With respect to the science of geometrical optics, it can be said that if the value of d2 is small, the smaller the value of d2 the higher the resolution power; however, if the effect of the diffraction of light is taken into consideration, the smaller the value of d2, the lower the resolution power. Taking the above-described to factors into consideration, the optimal value of d2 is determined. In general, the value of d2 is set to a convenient value of from several microns to several centimeters based on a consideration of the observation distance from the optical element 1, the application, or the size of the subject of projection, and the value of d1 can then be set corresponding to the d2 to from several microns to several centimeters, taking into consideration of the optimal viewing angle. The value of d2 can be set, for example, to a value of from several microns to several tens of microns in the case that the image of the subject of projection is to be observed at a close-range distance from the optical element 1 of from several millimeters to several centimeters; in the case that the image of the subject of projection is to be observed at a mid-range distance from the optical element 1 of from several centimeters to several meters, the value of d2 can be set to a value of from several tens of microns to several hundreds of microns, and in the case in the case that the image of the subject of projection is to be observed at a long-range distance from the optical element 1 of from several centimeters to several meters, the value of d2 can be set to a value of from several hundreds of microns to several millimeters.

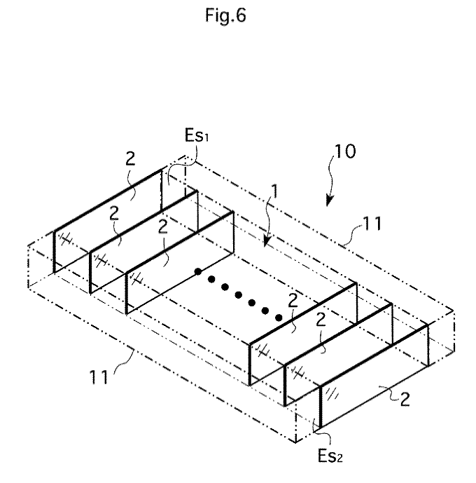

Note that even in the case that there is no particular mention made in the explanation of the two-point imaging optical device in each of the embodiments described below, the element planes Es₁ and Es₂ are shown in each drawings to which reference is made. FIG. 6 shows a schematic drawing of the basic configuration of an example of a two-point optical imaging device (hereinafter referred to simply as an “optical device”) which is an embodiment of the present invention utilizing the above-described optical element 1. The optical device 10 shown in FIG. 6 is of a configuration wherein both sides of the mirrored surface portions 2 (or a mirror member provided with said mirrored surface portions 2) occurring in the optical element 1 shown in FIG. 5 are supported by the two convenient supporting members 11 and 11 and 11. Each of the mirrored surface portions 2 is arranged in a mutually parallel state by the two supporting members 11, and in the example shown in the drawing, are supported so as to have an upright posture. The supporting member 11 is not particularly limited to being of a certain shape or size, and so long as the supporting function is capable of being performed, a rod shaped member, a panel shaped member, a line shaped member, or the like can be conveniently used as the supporting member 11. For example, in the case that a rod shaped member or a panel shaped member is used as the supporting member 11, a groove parallel to each mirror surfaced portion 2 is provided carved into the surface of the interior wall of each member, and by inserting the side edge portion of each mirrored surface portion 2 into a corresponding groove, the position and posture of the mirrored surface portions 2 can be maintained.

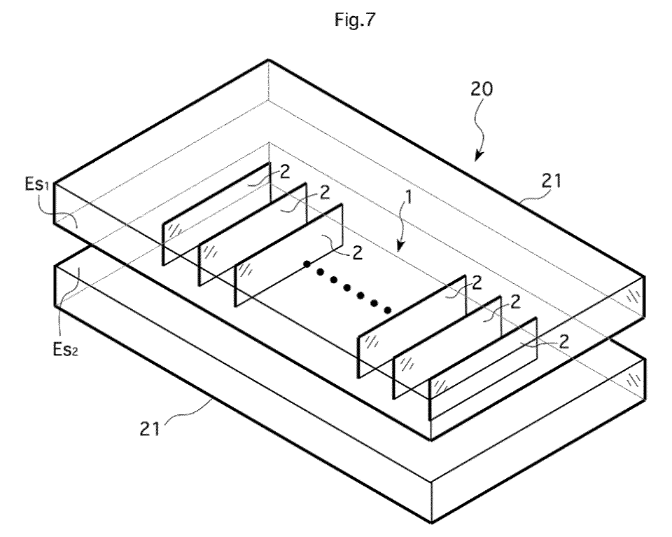

FIG. 7 is a schematic drawing of the configuration of another embodiment of an optical device according to the present invention utilizing the above-described optical element 1. The optical device 20 shown in FIG. 7 is of a configuration wherein two supporting members 21 and 21 are brought into contact with respective element planes Es₁ and Es₂ to sandwich the mirrored surface portions 2 therebetween. The two supporting members 21 and can be configured from hard transparent members that form a thin panel shape. Glass, acrylic or the like can be used as the material of the hard transparent members. The contacting surface of the two supporting members 21 and 21 that is brought into contact with the element planes Es₁ and Es₂ intersects at right angles with the surface of each of the mirrored surface portions 2. For example, a groove corresponding to the upper and lower edges of each of the mirrored surface portions 2 is carved into the contacting surface of each of the two supporting members 21 and 21 that is brought into contact with the element planes Es₁ and Es₂, and by inserting the upper and lower edge of each of the mirrored surface portions 2 into a corresponding groove, the position and posture of the mirrored surface portions 2 can be maintained, and it also becomes possible to protect the mirrored surface portions 2.

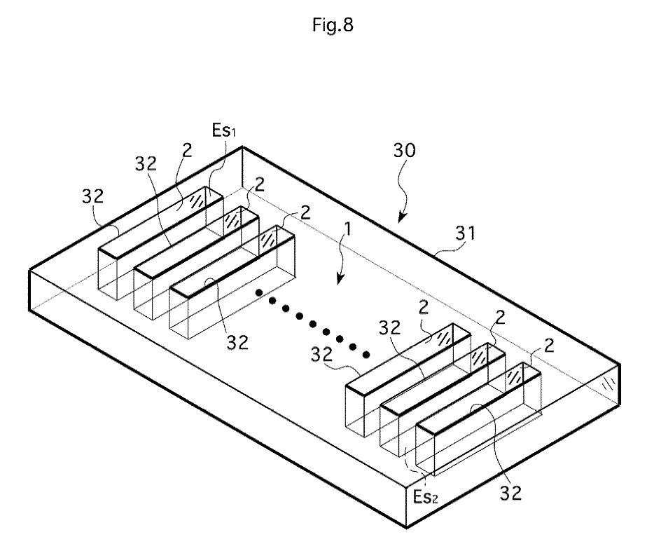

FIG. 8 is a schematic drawing of the configuration of yet another embodiment of an optical device according to the present invention utilizing the above-described optical element 1. The optical device 30 shown in FIG. 8 is of a configuration wherein a supporting member 31 configured from a hard transparent member that has been formed into a thin panel shape, in which a plurality of mutually parallel slits 32 have been formed passing through a direction of a thickness of a panel wall of the supporting member 31. Continuing, a respective mirrored portion 2 is formed on a surface among the surfaces on the interior of each slit 32 that faces toward the same single direction (though not shown in the drawing, the direction if that facing toward the subject of projection). Glass, acrylic or the like can be used as the material of the hard transparent members. For example, in the case that acrylic is adopted as the hard transparent member, by subjecting a surface of each of the slits 32 facing toward the same single direction to a mirror coating process, the mirrored surface portions 2 can be obtained. Further, because of the same reason described above, it is desirable that the rear surface of the mirrored surface portions 2 is a non-mirror surface. Here, in regard to the thickness of said hard transparent member, it is acceptable that the thickness be set so as to correspond to the width dimension d1 of the mirrored surface portions 2. With respect to the interval between adjacent slits slit 32 and slit 32, it is acceptable that the said interval be set to approximately half of the interval d2 between adjacent mirrored surface portions 2. Further, the opening width of each slit 32 can be, for example, made to be approximately half of the depth of the slit 32 (i.e., the thickness of the supporting member 31). By adopting a configuration such as that described above, the optical device 30 can be obtained by subjecting a supporting member 31 that has been formed from a single member to a process. Note that, instead of the slit 32 described above, a plurality of mutually parallel streak shaped grooves can be formed in the hard transparent member forming the supporting member 31 that do not pass through the thickness of a panel wall thereof, and by forming the mirrored surface portions 2 on the surface of the interior of each groove in the same manner as for the slits 32, an optical device of the same sort can be obtained.

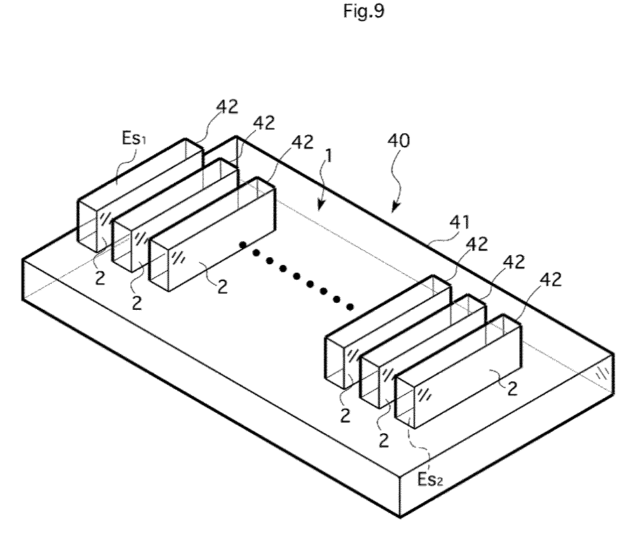

FIG. 9 is a schematic drawing of the configuration of yet still another embodiment of an optical device according to the present invention utilizing the above-described optical element 1. The optical device 40 shown in FIG. 9 is of a configuration wherein a plurality of mutually parallel thin and long protrusions 42 are formed protruding on one surface (in the drawing, the lower surface) of a hard transparent member configuring a supporting member 41, instead of the slits 32 occurring in the supporting member 31 of the optical device 30. The protrusions 42 can be of the same material as the supporting member 41. Continuing, a respective mirrored portion 2 is formed on a surface among surfaces on the exterior of each protrusion 42 that faces toward one direction (though not shown in the drawing, the direction if that facing toward the subject of projection). The mirrored surface portions 2 of the above described type can be obtained by the same sort of process employed in the case of the optical device 30. Further, because of the same reason described above, it is desirable that the rear surface of the mirrored surface portions 2 is a non-mirror surface. Here, in regard to the protruding height of the protrusions 42, it is acceptable that the protruding height be set so as to correspond to the width dimension d1 of the mirrored surface portions 2. With respect to the interval between adjacent protrusions protrusion 42 and protrusion 42, it is acceptable that the said interval be set to approximately half of the interval d2 between adjacent mirrored surface portions mirrored surface portion 2 and mirrored surface portion 2. Further, it is acceptable that the width of the protrusions 42 in the direction of a perpendicular line through the mirrored surface portions 2 be, for example, approximately half that of the height of the protrusions 42. By adopting a configuration such as that described above, the optical device 40 can be obtained by subjecting a supporting member 41 that has been formed from a single member to processing. Further, because the protrusions 42 also function as a “rib” of the thin panel shaped supporting member 41, the protrusions 42 also contribute to reinforcing the strength and maintaining the shape of the optical device 40. Note that, as a form of the protrusions configured such that the upper portion thereof forms a rectangular shaped gutter form opening in the upward direction, instead of the mirrored surface portions 2 that were formed on the exterior surface of the protrusions 42, the same effect as the optical device 40 can be obtained by an optical device having a configuration wherein a mirrored surface is formed on an interior wall surface parallel to the said exterior wall. In an even yet further embodiment of an optical device such as that described above, the opening of the gutter form is provided with a slit 32 such as the optical device 30 or a joint shaped groove instead of the slit 32 which is in communication with the said opening of the gutter form, whereby an optical device having the same effect can be obtained.

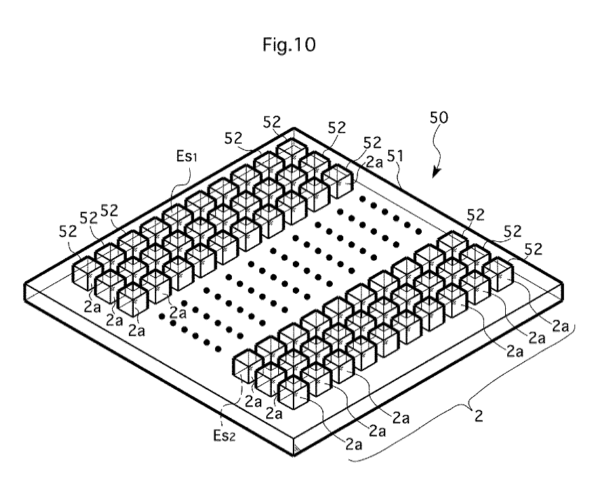

FIG. 10 is a schematic drawing of the configuration of yet still another embodiment of an optical device according to the present invention utilizing the above-described optical element 1. The optical device 50 shown in FIG. 10 is of a configuration wherein, in the same manner as the supporting member 41 of the optical device 40 shown in FIG. 9, protruding from one surface (in the drawing, the upper surface) of a supporting member 51 configured from a hard transparent member forming a flat panel shape are a plurality of minute rectangular body protrusions 52 so as to form a planar lattice pattern (i.e., a grid). Continuing, among exterior surfaces of the protrusions 52, a flat and smooth exterior surface facing toward the subject of projection is subjected to a mirror surfacing process to form mirror surface elements 2a. Further, because of the same reason described above, it is desirable that the rear surface of the mirrored surface portions 2 is a non-mirror surface. Still further, a single mirrored surface portion 2 has been formed by arranging a plurality of the mirrored surface elements 2a in a single row residing within a single plane facing toward the subject of projection. Here, in regard to the protruding height of each protrusion 52, it is acceptable that the protruding height be set so as to correspond to the width dimension d1 of the mirrored surface portions 2. With respect to the interval between adjacent rows of the protrusions 52, it is acceptable that the said interval be set so as to correspond to the interval d2 between adjacent mirrored surface portions 2. Further, the interval between adjacent protrusions protrusion 52 and protrusion 52 which form the same mirrored surface portion 2 can be set to a convenient interval, such as the same dimension as the above-described value d2. The optical device 50 of a configuration such as that described above can be said to have a configuration wherein the protrusions 42 occurring in the optical device 40 have been finely divided in the direction in which the plurality of protrusions 52 are lined up. Note that, in the same manner as the modified version of the optical device 40, the same effect as the optical device 50 can be obtained by an optical device of a configuration wherein the protrusions 52 of the optical device 50 are formed so that the upper portion thereof configures a rectangular shaped gutter form opening in the upward direction, and among exterior surfaces of the protrusions 52, a flat and smooth exterior surface facing toward the subject of projection is subjected to a mirror surfacing process to form mirror surface elements 2a.

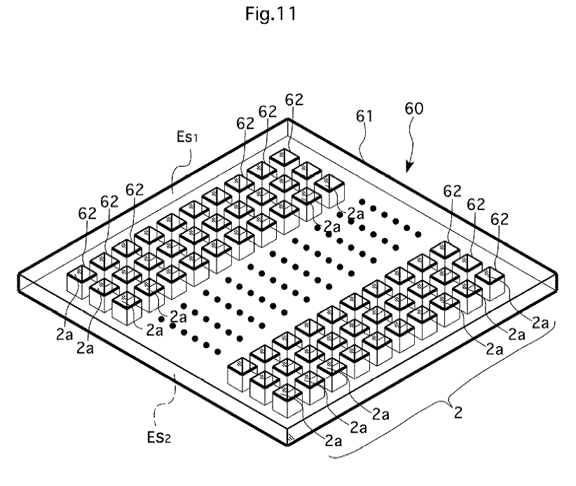

FIG. 11 is a schematic drawing of the configuration of even yet still another embodiment of an optical device according to the present invention utilizing the above-described optical element 1. The optical device 60 shown in FIG. 11 is of a configuration wherein, in the same manner as the supporting member 31 of the optical device 30 shown in FIG. 8, a plurality of rectangular shaped fine hole portions 62 passing through a thickness of a panel wall of a supporting member 61 configured from a hard transparent member forming a flat panel shape are provided so as to form a planar lattice pattern (i.e., a grid). Continuing, among interior surfaces of the hole portions 62, a flat and smooth interior surface facing toward the subject of projection is subjected to a mirror surfacing process to form mirror surface elements 2a. Further, because of the same reason described above, it is desirable that the rear surface of the mirrored surface portions 2 is a non-mirror surface. Still further, a single mirrored surface portion 2 has been formed by arranging a plurality of the mirrored surface elements 2a in a single row residing within a single plane facing toward the subject of projection. Here, in regard to the depth of each of the hole portions 62, it is acceptable that the depth be set so as to correspond to the width dimension d1 of the mirrored surface portions 2. With respect to the interval between adjacent rows of the hole portions 62, it is acceptable that the said interval be set so as to correspond to approximately half the interval d2 between two adjacent mirrored surface portions 2. Further, the interval between adjacent hole portions hole portion 62 and hole portion 62 which form the same mirrored surface portion 2 can also be set to a convenient interval, such as approximately half of the dimension of the above-described value d2. The optical device 60 of a configuration such as that described above can be said to have a configuration wherein the slits 32 occurring in the optical device 30 have been finely divided in the direction in which the plurality of hole portions 62 are lined up. Note that, instead of the hole portions 62 that pass through the supporting member 61, pores that have a bottom and do not pass through the thickness of a panel wall of the supporting member 31 can be formed in the hard transparent member configuring the supporting member 31 so as to form a lattice shape, and by forming mirrored surface portions 2a on a surface of an interior wall of each pore in the same manner as for the hole portions 62, an optical device of the same sort can be obtained.

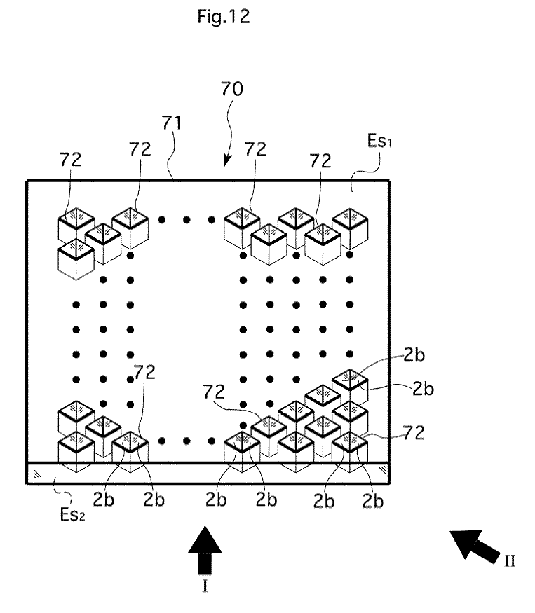

Note that, a two-point imaging optical device such as that described above can also be implemented by the optical device 70 shown in FIG. 12. The optical device 70 has substantially the same configuration as that of the above-described optical device 60, in which two interior surfaces crossing a hole portion 71 at a right angle have been provided as mirrored surface portions 2b, 2b; wherein, the basic usage method of the optical device 70 is such that a subject of projection is disposed at the lower portion of the optical device 70 so as to face toward the mirrored surface portions 2b, 2b from a direction on a center line from an angle formed by the mirrored surface portions 2b, 2b (indicated by “I” in the drawing), and light emitted from said subject of projection is reflected once from each of the two mirrored surface portions 2b, 2b for a total of two times, and the image of the subject of projection is projected so as to appear to be floating upward from above the optical device 70. According to an optical device such as the optical device 70, if an embodiment wherein the subject of projection is disposed so as to be counterposed to only one of either of the two mirrored surface portions 2b, 2b (indicated by “II” in the drawing), and a mirrored surface portion 2 is configured from said mirror surfaced portion 2b and a mirrored surface portion 2b of another hole portion 71 contained within the plane that (the said mirrored surface portion 2b performs the same role as the above-described mirrored surface portion 2a) is adopted, the configuration becomes the same as that of the above-described optical device 60, whereby it becomes possible to use the optical device 70 in the same manner as the optical device 60.

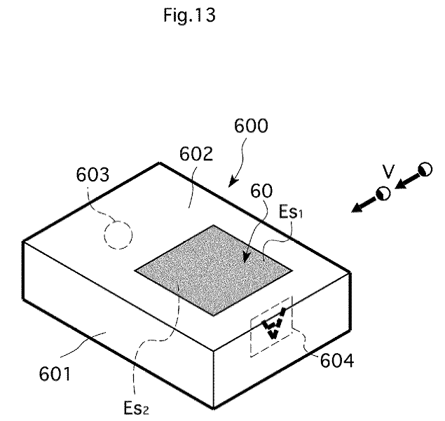

Hereinafter, with respect to an actual example of a display device applying the above-described optical device 60, the imaging system and forms of observation will be explained. Note that, although the optical device 60 is used for illustrative purposes in this example, any of the other above-described optical devices according to the present invention may be applied in the same manner. The display device 600 shown in FIG. 13 comprises a housing 601 that is impervious to light and is provided with an opening portion on an upper portion thereof, a lid 602 for covering the opening portion of the housing portion 601, and a light 603 disposed within the housing 601; wherein, the optical device 60 is disposed on a center portion of the lid 602, and light does not penetrate an square shaped area that surrounds the optical device 60. The subject of projection 604 as an aggregate of light of a point light source S (a piece of paper having written thereon the letter “A” in the example shown in the drawing) is counterposed to the mirrored surface portion 2 of the optical device 60 such that the image of the subject of projection 64 is projected onto lower surface side of the lid 602 with the top and bottom thereof inverted in an upside down position. The light 603 is disposed in contraposition to the subject of projection 604 so as to shine on the subject of projection 604 in the state in which the housing 601 is covered by the lid 602. An observer looks into the optical device 60 from a vantage point V located at a position above and at a diagonal to the subject of projection 604 occurring in the display device 600. Here, according to the display device 600 of the current example, an optical device in which each of the mirrored surface elements 2a is configured as a square with 100 micron sides, and with an interval between adjacent mirrored surface elements to the front, rear, left and right of 10 microns has been adopted as the optical device 60 is.

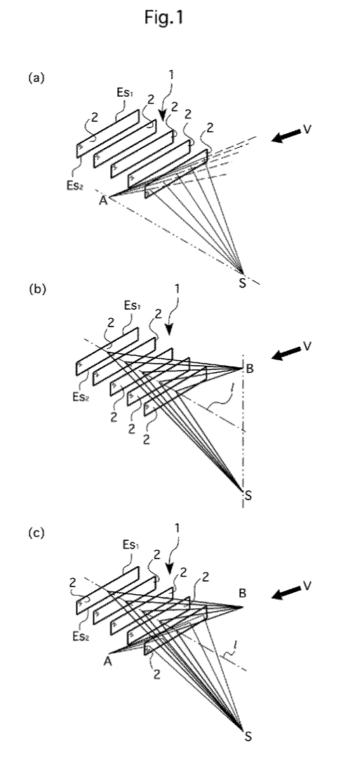

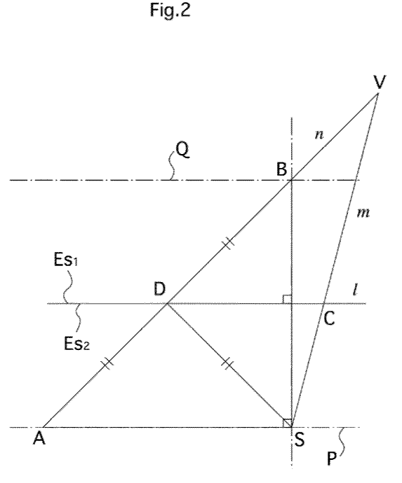

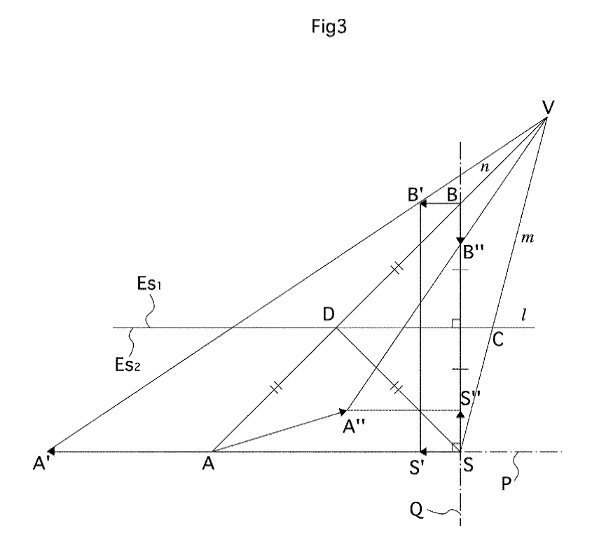

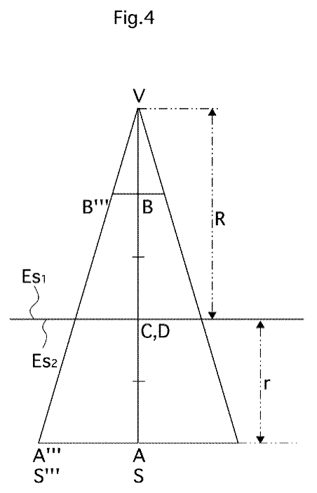

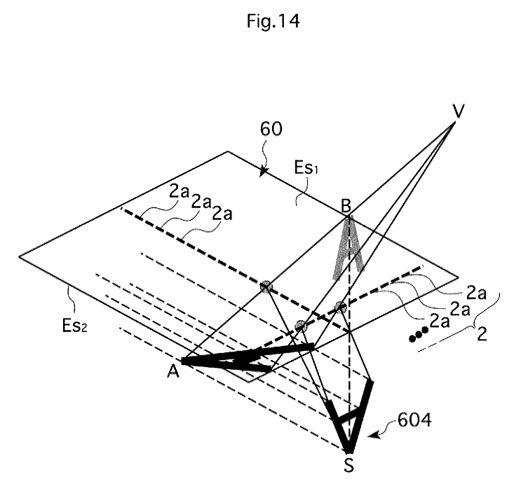

FIG. 14 shows an illustration of the light paths of light emitted by the light 603 and reflected by the subject of projection 604, and two projected images of the subject of projection 604. Note that in FIG. 14, because the actual width dimension of the mirrored surface portions 2, that is to say the interval between the element planes Es₁ and Es₂ is extremely small in comparison to the subject of projection or other objects, the upper surface and lower surface of the optical device 60 have been rendered in a mock representation as a single plane for ease of illustration. A point on top of the letter “A” that is the subject of projection (here, the peak of the letter “A”), will be designated by the letters S for the purpose of explanation, and as described above for FIGS. 1-4, light emitted from the point light source S is reflected (a point of reflection is indicated by a solid dot in the drawing) at a given mirrored surface portion 2 (if the mirrored surface portion 2 is divided into a plurality of mirrored surface portions 2a as in the case of optical device 60, the convergence at each mirrored surface portion 2a), whereby a virtual image is formed at a point A below the lower side element plane Es₂ of the optical device 60, and an real image (shown in grey in the drawing) is formed at a point B above the upper side element plane Es₁ of the optical device 60 from light that has been reflected at the mirrored surface portion 2a residing on a perpendicular line of the mirrored surface portion 2 that passes through the point S. That is to say, if the display device 600 is configured such that with the mirrored surface portion 2 of the optical device 60 is disposed so as to be in a vertical posture, when light that has been reflected at the point S on the subject of projection is reflected from the mirrored surface portion 2, the virtual image (a point at which the light is virtually focused) that the bundle of rays spreading in a lateral direction that impinges onto is the point A, and the real image (a point at which the light is actually focused) that the bundle of rays spreading in a longitudinal direction which is a direction parallel to the common perpendicular line 1 running through each of the mirror surfaced portions 2 is the point B.

However, in the case in which observation is made from a given single point V located in a direction above the display device 600 with a single eye, because the point A and the point B reside along the same single line of sight, it is not possible to distinguish the point A and the point B. If a case is assumed in which alignment with a focal length is made in a highly precise manner, the focal point will match at the two distances of the point A and the point B. Even light that has been reflected at another point on the subject of projection 604, and again reflected at the mirrored surface portion 2, respective images will be formed at the corresponding positions on both the upper and lower sides of the element plane. In regard to the image of the letter “A” obtained in this manner, with respect to the lower position image (i.e., the virtual image) formed on the lower side element plane Es₂, although there is no change in the lateral width thereof, which is the equivalent of that of the subject of projection 604, the image is stretched and elongated in the longitudinal and depth-wise directions; with respect to the image formed above the upper side element plane Es1 (i.e., the real image), although there is no change in the dimension in the vertical and depth-wise directions thereof, which are the equivalent of those of the subject of projection 604, the dimension of the lateral width thereof is contracted. However, in the case that the above-described images are viewed with the above-described single point V as the vantage point, the two images appear to be completely overlapping, and only a single letter “A” is seen. Note that, when viewed by both eyes, with a parallax component therebetween, it is possible to resolve and confirm the upper position image or the lower position image. More specifically, in the case that an optical means 60 comprising an optical element 1 (refer to FIG. 6, etc.), which is provided with horizontally disposed element planes Es1 and Es2 and a mirrored surface portion 2 disposed vertically, is employed, for a normal observer viewing from a normal posture with both eyes, it becomes easier to view the virtual image formed below the lower side element plane Es2 by the bundle of rays travelling in the lateral direction in a natural manner. With respect to the real image formed above the upper side element plane Es1 by the bundle of rays travelling in the longitudinal direction, if the observer turns his or her face sideways so as to align both eyes in a vertical plane, it becomes possible to view the image in a natural manner.

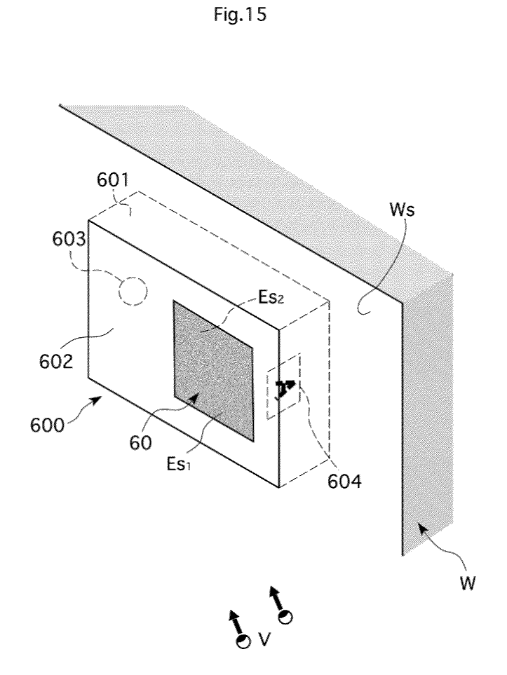

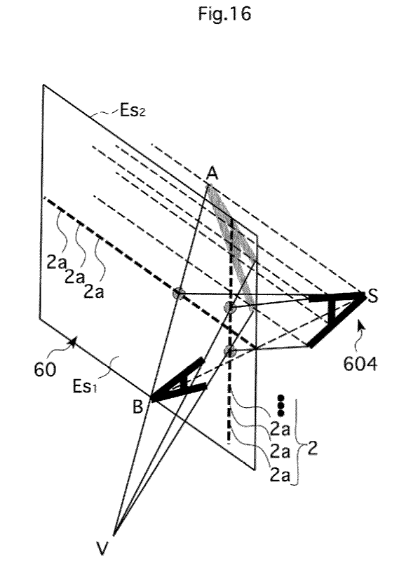

In particular, if an observer is to view the real image formed by the bundle of rays travelling in the longitudinal direction with his or her face in the natural, upright posture, it is acceptable that the element planes Es1 and Es2 and the mirrored surface portions 2 of the two-point imaging optical element 1 occurring in the optical device 60 are disposed so as to be in a vertical posture. The example shown in FIG. 15 is an embodiment in which the above-described display device 600 has been embedded standing on its end in a wall W, which is an upright body, and the upper side element plane Es1 and lid body 602 are vertically aligned flush with a wall surface Ws. The direction in which the display device 600 is stood is a direction in which each of the mirrored surface portions 2 becomes disposed in a vertical posture. As shown in FIG. 16, in conformance with FIG. 14, the subject of projection 604 (i.e., the letter “A” laid on its side toward the right) is disposed on the interior of the wall W. In this manner, as shown in the enlargement of FIG. 16, when an observer views from a natural posture from the vantage point V located before the wall Ws (in actuality with both eyes), because the binocular disparity comes to exist in a perpendicular direction with respect to the element plane Es1, the real image comes to be viewed appearing at a position closer to that of the observer than the wall Ws of the element plane Es1. Note that, in regard to the above-described real image, although it is not changed in the longitudinal (in the drawing, the horizontal direction) and depth-wise directions thereof, which are the equivalent of those of the subject of projection, the width of the letter “A” (in the drawing, the vertical direction) is contracted; in particular, in the case that the real image is a 3D image, it comes to appear to the observer as an image in which the ordering of the depth characteristics of the subject of projection 604 has been inverted. Note that, in the current example, opposite to the case of FIG. 14, if the observer turns his or her face sideways and views the images, the virtual image (shown in grey in FIG. 16) becomes visible on the interior side of the wall Wa.

A case in which a flat subject of projection is observed has been explained above; however, it is possible to view an image of a 3D subject of projection in the same manner. However, in the case that the subject of projection is a 3D object, the depth characteristics of the real image formed in the space on the same side as the vantage point of the observer with respect to the element planes appear inverted. Further, although the ordering of the depth characteristics of the virtual image formed in the space on the same side as the subject of projection with respect to the element planes is not inverted, the image becomes stretched and elongated in the depth-wise direction thereof.

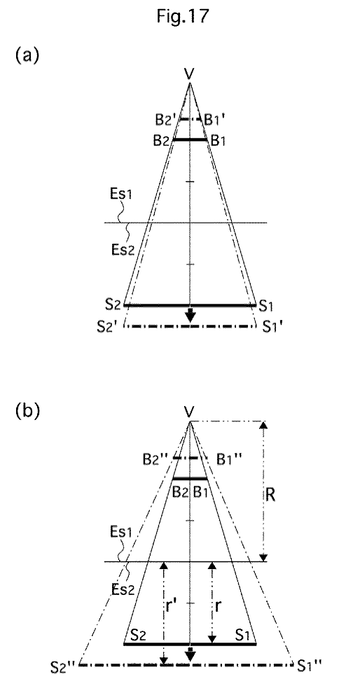

Still further, although a description for the case in which the subject of projection is a stationary body (including a stationary image) has been provided above, it is also possible that the subject of projection is an object or an image that moves, in which case the image of the subject of projection can be observed as an real image and a virtual image with movement. As shown in FIG. 17, for example, in a case in which the subject of projection has movement in a perpendicular direction with respect to the element planes Es₁ and Es₂, the distortion occurring in a lateral direction when viewed from a fixed vantage point V will be explained in conformance with the relations illustrated in FIG. 17. A subject of projection positioned along a line segment S1S2 (hereinafter referred to as “subject of projection S1S2) is disposed in a space to the side of the Es2 element plane, and an real image B₁B₂ of the subject of projection S1S2 formed in a space on the side of the Es2 element plane is observed from the vantage point V. As shown in FIG. 17a, assuming that the subject of projection S1S2 has been moved in a perpendicular direction away from the element planes Es₁ and Es₂ to the position S1′S2′, the real image is moved from the position B1B2 to the position B1′B1′ so as to be distanced from the element planes Es₁ and Es₂ the perpendicular direction therefrom, whereby the image receives a geometric effect and is thereby contracted. If the subject of projection S1S2 is moved in the perpendicular direction toward the element planes Es₁ and Es₂, the real image thereof is moved from the position B1B2 in the perpendicular direction toward the element planes Es₁ and Es₂ and enlarged. Further, as shown in FIG. 17b, even if the subject of projection S1S2 is moved in a perpendicular direction with respect to the element planes Es1 and Es2, in order to render observable an real image B1″B2″ of which the size thereof is unchanged from that of the real image B1B2, in the case, for example, in which the subject of projection S1S2 cannot be moved away from the element surfaces Es1 and Es2, the subject of projection S1S2 can be expanded to a subject of projection S1″S2″ so as to preserve in proportion analogous shapes of the triangular shapes VB1″B2″ and VS1″S2″. More specifically, given a distance R from the element surfaces Es1 and Es2 from the vantage point V, a distance r from the element surfaces Es1 and Es2 to the subject of projection S1S2, and a distance r′ from the element surfaces Es1 and Es2 the subject of projection S1″S2″ after the subject S1S2 has been moved, it is acceptable if the size of the subject of projection S1″S2″ after said subject of projection has been moved from the S1S2 position to the S1″S2″ position is made to satisfy the following formula.

S1″S2″={(R−r)/(R+r)}{(R+r′)/(R−r′)}S₁S₂ Formula 2

In this manner, to freely enlarge or contract the width of the subject of projection in a direction parallel with the element plane and mirrored surface portion, it is preferable that a display device is adopted as the subject of projection, or that an image projected onto a screen is adopted. Note that, in the case that each part of the subject of projection is not a uniform distance from the element plane, by again expanding or contracting the width of the subject of projection according to the distance thereof from the element plane, it becomes possible to reproduce an image at a correct size.

Note that, the present invention is not limited to the above-described embodiments. A specific configuration of each part or component is also not limited to the above described embodiments; so long as the gist of the present invention is not deviated from, any number of variations are possible.

### INDUSTRIAL APPLICABILITY OF THE INVENTION

By reflecting light emitted from a light source disposed in a space on the side of a rear surface of an imaging element by a mirrored surface portion with which the optical element is provided, when viewed from a given vantage point, an real image appears to be formed to the front of said optical element and a virtual image to the rear of said optical element; moreover, the real image and the virtual image can be viewed along the same straight line of sight, whereby it can be said that an optical element provided with a new type of imaging system and a new optical device can be provided, and that it is possible to apply the new optical device and new optical element in a new type of display, and the like.

1. A two-point imaging optical device that is provided with a two-point imaging optical element, the two-point imaging optical element comprising: a plurality of mirrored surface portions disposed at a perpendicular angle or at an angle close to perpendicular in a narrow interval between two parallel planes, which form an element plane, so as to be sandwiched between the planes to form a flat panel shape; wherein, the plurality of mirrored surface portions are disposed so as to be mutually isolated and parallel or having an angle close to parallel therebetween, and an image of a subject of projection that has been disposed on one side of the element plane is formed in a space on the said one side of the element plane and another image of the said subject of projection is formed on the other side of the element plane, respectively.

2. A two-point imaging optical device according to claim 1, wherein a rear surface of the plurality of mirrored surface portions is a non-mirror surface.

3. A two-point imaging optical device according to either of claim 1, wherein the plurality of mirrored surface portions is formed from a plurality of mirrored surface elements each of which is disposed substantially within the same plane and mutually separated.

4. A two-point imaging optical device according to claim 1, further comprising a supporting member for supporting the two-point imaging optical element and the plurality of mirrored surface portions occurring in the two-point imaging optical element so that all of said mirrored surface portions are oriented in the same direction, and are mutually isolated and parallel or have an angle close to parallel therebetween; wherein in the case that the subject of projection has been disposed in a space on a rear side of the supporting member and counterposed to the mirrored surface portions, the image of the subject of projection that passes through an interval between each of the mirrored surface portions and is reflected at each mirrored surface portion is formed as a different image in each of a space on the front surface side and the rear surface side of the supporting member, respectively.

5. A two-point imaging optical device according to claim 4, wherein the supporting member is formed of hard transparent members sandwiching the plurality of mirrored surface elements along the two element planes and disposed so as to be mutually horizontal or have a posture that is close to horizontal.

6. A two-point imaging optical device according to claim 4, wherein the supporting member is configured of a thin panel shaped member formed of a transparent hard material on which are formed a plurality of mutually parallel or having an angle close to parallel therebetween streak-shaped grooves, slits, or protrusions, and a surface of each streak-shaped groove, slit, or protrusion that is counterposed to the side on which the subject of projection is disposed has been made into the mirrored surface portion.

7. A two-point imaging optical device according to claim 4, wherein the supporting member is configured of a thin panel shaped member on which are formed a plurality of hole portions that pass through a direction of a thickness of a panel wall, or a plurality of transparent tube shaped portions that protrude in a direction of a thickness of the panel wall, the plurality of hole portions or tube shaped portions are arranged in a planar lattice pattern, a mirrored surface element for reflecting light is formed on a surface among surfaces of each hole portion or tube shaped portion that faces toward the same side, and a single mirrored surface portion is configured from a plurality of mirrored surface elements formed substantially within the same plane.

8. A two-point imaging optical device according to claim 7, wherein an interior portion of the hole portions or tube shaped portions fulfills the property of a transparent liquid or solid that has a refractive index greater than 1.

9. A two-point imaging optical device according to claim 4, wherein the subject of projection is disposed to the rear surface side of the supporting member counterposed to the mirrored surface portions, and the subject of projection is an inverted three-dimensional object or an inverted three-dimensional image of which the ordering of the depth characteristics has been inverted.

10. A two-point imaging optical device according claim 4, wherein the subject of projection is disposed to a rear surface side of the supporting member in contraposition to the mirrored surface portions, and the subject of projection is an object or image having movement.

11. A two-point imaging optical device according to claim 1, wherein the subject of projection is an object or image of which a width in a direction parallel to the element plane and the mirrored surface portions can be expanded or contracted according to the distance from the element plane.

12. A two-point imaging optical device according to claim 1, wherein the two-point imaging optical element is disposed such that a bearing of the element plane and the mirrored portions becomes vertical.

13. A two-point imaging optical device according to claim 1, wherein the two-point imaging optical element is disposed such that a bearing of the element plane becomes horizontal and a bearing of the mirrored portions becomes vertical.
